(19) United States
(12) Patent Application Publication
(10) Pub. No.: US 2007/0061620 A1
(43) Pub. Date: Mar. 15, 2007

(54) Embedded system and program and key interruption control method

(75) Inventor: Masataka Watanabe, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC SOFT. LTD., Tokyo (JP)

(21) Appl. No.: 11/516,714

(22) Filed: Sep. 7, 2006

(30) Foreign Application Priority Data
Sep. 9, 2005 (JP) 2005-262298

(51) Int. Cl. G06F 11/00

(52) U.S. Cl. 714/12

(57) ABSTRACT

When key interruption is notified to an application in a embedded system like a portable information terminal, sometimes notification of a key event to CPU is not carried out appropriately. A key controller includes a key table containing key information which specifies key type and operation style valid to execution of application by the CPU and notification information which specifies notification style to the interruption controller for each key. A key control unit of the key controller sets key information and notification information corresponding to the application which the CPU executes, in a register of the key controller and notifies the interruption controller of generation of key interruption corresponding to key operation based on the set information.

### BACKGROUND OF THE INVENTION

1. Field of the Invention

The present invention relates to an interruption system like a portable information terminal, more particularly to control processing when key operation is carried out in a system.

2. Description of the Related Art

An example of control on key operation in a conventional embedded system will be described using hardware configuration diagram of FIG. 2 and software configuration diagram of FIG. 9. Assume that the embedded system is a portable information terminal 2 composed of event driven type software control function, human interface such as key button, display function, application programs and other hardware function/software function not shown. The software configuration shown in FIG. 9 corresponds to a program existing on a memory device 2-15 for executing CPU2-1 of FIG. 2.

A conventional flow in which key event is notified to the application 9-4 when a key button 2-5 of the portable information terminal 2 is pressed will be described with reference to FIG. 2. First, when user presses the key button 2-5, it is notified to a key controller 2-8 in a system controller 2-3 through a key signal 2-4 that the status of the key button 2-5 is changed. The key controller 2-8 specifies a key whose status is changed through a key matrix processing unit 2-13 and executes key interruption notification 2-14 to an interruption controller 2-9 by the key control unit 2-12. Then, it is notified that interruption to the CPU2-1 occurs from the interruption controller 2-9 according to an interruption signal 2-11.

After receiving the interruption signal 2-11, the CPU2-1 executes a processing of determining an interruption factor by a kernel 9-1 of FIG. 9 to execute interruption handler 9-3 corresponding to the determined interruption factor. The interruption handler 9-3 is a program prepared for each interruption factor to the CPU2-1 and the interruption handler 9-3 corresponding to the key processing is executed.

The key processing interruption handler 9-3 reads a register (not shown) of the key controller 2-8 at a specified time interval using a timer function provided by an operating system (hereinafter referred to as “OS”) of the portable information terminal 2 and executes polling processing in order to verify the status of a key to remove chattering of the signal.

Here, a procedure for chattering determination by the key processing interruption handler 9-3 will be described with reference to a flow chart of FIG. 12. The key processing interruption handler 9-3 reads a register in the key controller 2-8 regularly, for example, at every 100[ms] using the timer controller 2-8 (step S1) to compare with previously read data (step S2). As a result, unless it meets the previously read data, the interruption handler 9-3 clears the counter (step S3) and waits for next interruption by the timer (step S4).

On the other hand, if the previously read data meets current data, the interruption handler 9-3 adds the data to the counter (step S5) and determines whether or not the counter value reaches a predetermined count, for example, three times (step S6). As a result, unless the counter value reaches three times, the timer is reset (step S7). If the counter value reaches three times, the interruption handler 9-3 clears the counter (step S8) and notifies the valid key to a middleware 9-2 (step S9).

The interruption handler 9-3 notifies information of the key pressed by user to the middleware 9-2. The middleware 9-2 notifies a key event to each application 9-4 based on setting information for the key operation set preliminarily for the application 9-4.

Notification styles about the key event which occurs when a key is pressed by means of the middleware 9-2 include a style of notifying the application 9-4 of the key pressing event when user presses the key (hereinafter referred to as “notification of key pressing when it is pressed) and a style of notifying the application 9-4 of the key pressing event when user releases the key (hereinafter referred to as “notifying of key pressing event when it is released).

The portable information terminal 2 classifies the key operation styles to three events, key pressing, key releasing and long period key pressing. The key pressing event is an event which notifies the application 9-4 when user presses the key button 2-5. The key releasing event is an event which notifies the application 9-4 when user's hand is released from the pressed key. The long period key pressing is an event which notifies that user continues to press the key without releasing it in a specified period.

The long period pressing event will be described further. Generally when it is notified the middleware 9-2 that the key button 2-5 is pressed according to the prior art, the middleware 9-2 determines whether the long period key pressing is valid/invalid. The middleware 9-2 is set to receive a notification of period expiration when a pressing period which specifies the long period key pressing elapses.

The middleware 9-2 determines whether the long period key pressing is valid or invalid based on order of receiving the notification of key release. For example, if notification is received from the timer prior to the notification of the key release, it is determined that the long period key pressing is valid.

The conventional methods about the key control of the portable information terminal include for example, methods described in patent document 1 and patent document 2 described later. The patent document 1 has proposed a method for simplifying an outgoing operation of the portable phone. When a specified time elapses with the key operating unit related to one-touch dialing pressed, this portable phone determines it to be one-touch dial operation by the long period pressing and displays the phone number of that dial.

The patent document 2 has described the portable communication terminal in which the pressing notification by the key operation and the notification of pressing release are inputted to CPU. The CPU starts the timer when it receives the notification of the pressing and if the timer ends before the pressing release is notified, it determines that current key operation is long period key pressing.

Patent document 1: Japanese Patent Application Laid-Open No. 2001-127869

Patent document 2: Japanese Patent Application Laid-Open No. 2002-259032

A first problem of the above-described conventional art is that any key event is not notified to the application 9-4 because of certain OS type of the portable information terminal or CPU loading condition. For example, if an interruption having a higher preference than the key interruption is generated when other OS than real-time OS is used or the CPU is loaded highly, the notification of the key event to the application 9-4 is likely to be delayed because the middleware 9-2 cannot recognize the key interruption quickly.

If the OS of the portable information terminal 2 is, for example, Linux (version prior to kernel version 2.4), the middleware 9-2 cannot exchange data directly with the interruption handler 9-3. Thus, the kernel 9-1 is interposed to exchange data between the both. That is, the kernel 9-1 copies the key interruption notification from the interruption handler 9-3 into a memory and the middleware 9-2 uses the copied data. Thus, each time when the key interruption occurs in the portable information terminal having this kind of OS, the CPU2-1 is likely to be loaded highly because copy processing by the CPU2-1 is required.

Assume that the OS of the portable information terminal 2 is not real time OS and the processing load of the CPU2-1 is high loading. If the key release interruption processing is delayed and the timer ends in that period, the middleware 9-2 determines that the current key pressing is long period pressing even if user's key operation is not long period pressing but a pressing in a moment. Consequently, such a waste processing that the long period key event not meeting actual user key operation is notified to the application 9-4 occurs.

A second problem exists in that the determination about the notification style of a key event to the application 9-4 and determination about long period pressing are carried out by the middleware 9-2. Thus, even when the application 9-4 uses the notification of the pressing when the key is released, the key controller 2-8 needs to notify the CPU 2-1 of a key interruption not only at the time of key release but also key pressing which is generated before that.

A third problem exists in that the determination about chattering at the time of key operation is carried out with software such as interruption handler 9-3 executed by the CPU2-1. Generally, the internal frequency of the CPU2-1 or a control signal of CPU peripheral circuit uses a relatively high clock of, for example, 100 milliseconds or more as a clock for confirming removal of chattering of the key operation. Thus, much power is consumed for the confirmation processing. If load on the CPU2-1 is high when the chattering in the key operation is determined by the interruption handler 9-3, the interruption handler 9-3 determines that the key operation is invalid. Because, it is not possible that the handler reads a key status register on real time. Thereby producing a possibility that some key operation fails.

A fourth problem exists in that if the key interruption occurs in an application switch period, this cannot be met. More specifically, if the portable information terminal includes a window system bearing screen display function, a generated key event is notified to an application through the window system. If image information for use in the window system is set up for each application, the window system changes over the screen with the switch of the applications.

Thus, if a new key event is generated during the switch of the applications, this new key event cannot be notified to the application because the window system is executing the screen switch processing. As a result, the new key event is lost.

The portable information terminal which distinguishes the application by the unit of a task regards a switch of the tasks as a switch of the applications. Cases of changing over the task include a case of starting a new task by executing initialization from a task which has been initialized and currently activated and if the type of OS does not accept an interruption during the initialization at this time, the interruption processing by user's key operation is delayed.

### SUMMARY OF THE INVENTION

Accordingly the present invention has been achieved in views of the above-described problems and an object of the invention is to provide a method for processing the key operation in a built-in system like the portable information terminal appropriately and effectively regardless of the OS type and CPU load condition.

To achieve the above-described object, according to an aspect of the present invention, there is provided:

(1) An embedded system comprising: a key button which user operates; a CPU which executes an application; an interruption controller which supplies a key operation interruption signal to the CPU; and a key controller for notifying the interruption controller of generation of a key interruption based on a key signal indicating a status change of the key button, wherein

the key controller includes:

a key table containing key information which specifies the key type and operation style valid to execution of application by the CPU and notification information which specifies notification style to the interruption controller for each key; and

a key control unit which sets key information and notification information corresponding to an application which the CPU executes, in a register of the key controller and notifies the interruption controller of generation of key interruption corresponding to key operation based on the set information.

(2) The embedded system described in the preceding paragraph (1) wherein the key controller includes a buffer which memorizes information about type and operation style indicated by a key signal from the key button and

the key control unit compares memory capacity necessary for information to be stored in the buffer with the amount of space in the buffer and if the amount of space in the buffer is smaller, aborts the information.

(3) The embedded system described in the preceding paragraph (2) wherein if notification of a key interruption when the key is released after it is pressed is set as notification information corresponding to the key signal, which indicates that the key is pressed and is to be stored in the buffer, the key control unit retains notification of key interruption relating to the key until the key signal indicating a release of the key is stored into the buffer.

(4) The embedded system described in the preceding paragraph (2) wherein the key controller includes a key control timer for timekeeping and;

if long period key pressing which keeps the key pressed in a predetermined period based on the timekeeping of the key control timer is set as key information corresponding to a key signal, which indicates that the key is pressed and is to be stored in the buffer, the key control unit sets the predetermined period in the key control timer and stores information indicating that the long period key pressing is valid when it is notified that the key control timer expires before the key signal indicating release of the key is stored into the buffer.

(5) The embedded system described in the preceding paragraph (3) wherein the key controller includes a key control timer for timekeeping and;

if long period key pressing which keeps the key pressed in a predetermined period based on the timekeeping of the key control timer is set as a key information corresponding to a key signal, which indicates that the key is pressed and is to be stored in the buffer, the key control unit sets the predetermined period in the key control timer and stores information indicating that the long period key pressing is valid when it is notified that the key control timer expires before the key signal indicating release of the key is stored into the buffer.

(6) The embedded system described in the preceding paragraph (1) or (2) or (3) or (4) or (5) wherein the speaker has a sound control unit for dispatching an acoustic signal to the speaker,

the key control unit notifies the sound control unit of generation of key interruption and

the sound control unit transmits an acoustic signal triggered by a notification from the key control unit.

(7) A computer program product which makes a CPU of the embedded system comprising: a key button which user operates; the CPU which executes an application; an interruption controller which supplies a key operation interruption signal to the CPU; and a key controller for notifying the interruption controller of generation of a key interruption based on a key signal indicating a status change of the key button, wherein

the key controller includes a key table containing key information which specifies the key type and operation style valid to execution of application by the CPU and notification information which specifies notification style to the interruption controller for each key, a key control unit which sets key information and notification information corresponding to the application which the CPU executes in a register of the key controller and notifies the interruption controller of generation of key interruption corresponding to key operation based on the set information; and a buffer which memorizes information about type and operation style indicated by a key signal from the key button, and

the key control unit compares memory capacity necessary for information to be stored in the buffer with the amount of space in the buffer and if the amount of space in the buffer is smaller, aborts the information,

execute a step of, when a key operation interruption signal is received from the interruption controller, reading out key read data containing information stored in the buffer from the register of the key controller and notifying the application of generation of the key event based on the read out key read data; and

a step of specifying to stop notification from the key controller to the interruption controller in the register of the key controller during switch of the applications.

(8) A computer program product which makes a CPU of an embedded system comprising: a key button which user operates; the CPU which executes an application; an interruption controller which supplies a key operation interruption signal to the CPU; and a key controller for notifying the interruption controller of generation of a key interruption based on a key signal indicating a status change of the key button, wherein

the key controller includes a key table containing key information which specifies the key type and operation style valid to execution of application by the CPU and notification information which specifies notification style to the interruption controller for each key, a key control unit which sets key information and notification information corresponding to the application which the CPU executes in a register of the key controller and notifies the interruption controller of generation of key interruption corresponding to key operation based on the set information; and a buffer which memorizes information about type and operation style indicated by a key signal from the key button, and

the key control unit compares memory capacity necessary for information to be stored in the buffer with the amount of space in the buffer and if the amount of space in the buffer is smaller, aborts the information; and if notification of a key interruption when the key is released after it is pressed is set as notification information corresponding to the key signal, which indicates that the key is pressed and is to be stored in the buffer, the key control unit retains notification of key interruption relating to the key until the key signal indicating a release of the key is stored into the buffer,

execute a step of, when a key operation interruption signal is received from the interruption controller, reading out key read data containing information stored in the buffer from the register and notifying the application of generation of the key event based on the read out key read data; and

a step of specifying to stop notification from the key controller to the interruption controller in the register during switch of the applications.

(9) A computer program product which makes a CPU of an embedded system comprising: a key button which user operates; the CPU which executes an application; an interruption controller which supplies a key operation interruption signal to the CPU; and a key controller for notifying the interruption controller of generation of a key interruption based on a key signal indicating a status change of the key button, wherein

the key controller includes a key table containing key information which specifies the key type and operation style valid to execution of application by the CPU and notification information which specifies notification style to the interruption controller for each key, a key control unit which sets key information and notification information corresponding to the application which the CPU executes in a register of the key controller and notifies the interruption controller of generation of key interruption corresponding to key operation based on the set information; a buffer which memorizes information about type and operation style indicated by a key signal from the key button; and a key control timer for timekeeping and

the key control unit compares memory capacity necessary for information to be stored in the buffer with the amount of space in the buffer and if the amount of space in the buffer is smaller, aborts the information; and if long period key pressing which keeps the key pressed in a predetermined period based on the timekeeping of the key control timer is set as a key information corresponding to a key signal, which indicates that the key is pressed and is to be stored in the buffer, the key control unit sets the predetermined period in the key control timer and stores information indicating that the long period key pressing is valid when it is notified that the key control timer expires before the key signal indicating release of the key is stored into the buffer,

execute a step of, when a key operation interruption signal is received from the interruption controller, reading out key read data containing information stored in the buffer from the register and notifying the application of generation of the key event based on the read out key read data; and

a step of specifying to stop notification from the key controller to the interruption controller in the register during switch of the applications.

(10) A computer program product which makes a CPU of an embedded system comprising: a key button which user operates; the CPU which executes an application; an interruption controller which supplies a key operation interruption signal to the CPU; and a key controller for notifying the interruption controller of generation of a key interruption based on a key signal indicating a status change of the key button, wherein

the key controller includes a key table containing key information which specifies the key type and operation style valid to execution of application by the CPU and notification information which specifies notification style to the interruption controller for each key, a key control unit which sets key information and notification information corresponding to the application which the CPU executes in a register of the key controller and notifies the interruption controller of generation of key interruption corresponding to key operation based on the set information; a buffer which memorizes information about type and operation style indicated by a key signal from the key button; and a key control timer for timekeeping and

the key control unit compares memory capacity necessary for information to be stored in the buffer with the amount of space in the buffer and if the amount of space in the buffer is smaller, aborts the information; if notification of a key interruption when the key is released after it is pressed is set as notification information corresponding to the key signal, which indicates that the key is pressed and is to be stored in the buffer, the key control unit retains notification of key interruption relating to the key until the key signal indicating a release of the key is stored into the buffer; and if long period key pressing which keeps the key pressed in a predetermined period based on the timekeeping of the key control timer is set as a key information corresponding to a key signal, which indicates that the key is pressed and is to be stored in the buffer, the key control unit sets the predetermined period in the key control timer and stores information indicating that the long period key pressing is valid when it is notified that the key control timer expires before the key signal indicating release of the key is stored into the buffer,

execute a step of, when a key operation interruption signal is received from the interruption controller, reading out key read data containing information stored in the buffer from the register and notifying the application of generation of the key event based on the read out key read data; and

a step of specifying to stop notification from the key controller to the interruption controller in the register during switch of the applications.

(11) A computer program product which makes a CPU of the embedded system comprising: a key button which user operates; CPU which executes an application; an interruption controller which supplies a key operation interruption signal to the CPU; a key controller for notifying the interruption controller of generation of a key interruption based on a key signal indicating a status change of the key button; a speaker; and a sound control unit for dispatching an acoustic signal to the speaker, wherein

the key controller includes key information which specifies the type of a key valid for execution of application by the CPU and notification information which specifies notification style to the interruption controller for each key, and a key control unit which sets key information and notification information corresponding to the application which the CPU executes in a register of the key controller and notifies generation of key interruption corresponding to key operation based on the set information to the interruption controller,

the key control unit notifies the sound control unit of generation of key interruption,

the sound control unit transmitting an acoustic signal triggered by a notification from the key control unit,

execute a step of, when a key operation interruption signal is received from the interruption controller, reading out key read data containing information stored in the buffer from the register and notifying the application of generation of the key event based on the read out key read data; and a step of specifying stopping notification from the key controller to the interruption controller in the register during switch of the applications.

(12) A computer program product which makes a CPU of an embedded system comprising: a key button which user operates; CPU which executes an application; an interruption controller which supplies a key operation interruption signal to the CPU; a key controller for notifying the interruption controller of generation of a key interruption based on a key signal indicating a status change of the key button; a speaker; and a sound control unit for dispatching an acoustic signal to the speaker, wherein

the key controller includes key information which specifies the type of a key valid for execution of application by the CPU and notification information which specifies notification style to the interruption controller for each key, a key control unit which sets key information and notification information corresponding to the application which the CPU executes in a register of the key controller and notifies generation of key interruption corresponding to key operation based on the set information to the interruption controller and a buffer which memorizes information about type and operation style indicated by a key signal from the key button,

the key control unit compares memory capacity necessary for information to be stored in the buffer with the amount of space in the buffer and if the amount of space in the buffer is smaller, aborts the information; and notifies the sound control unit of generation of key interruption,

the sound control unit transmitting an acoustic signal triggered by a notification from the key control unit,

execute a step of, when a key operation interruption signal is received from the interruption controller, reading out key read data containing information stored in the buffer from the register and notifying the application of generation of the key event based on the read out key read data; and a step of specifying stopping notification from the key controller to the interruption controller in the register during switch of the applications.

(

13) A computer program product which makes a CPU of an embedded system comprising: a key button which user operates; CPU which executes an application; an interruption controller which supplies a key operation interruption signal to the CPU; a key controller for notifying the interruption controller of generation of a key interruption based on a key signal indicating a status change of the key button; a speaker; and a sound control unit for dispatching an acoustic signal to the speaker, wherein

the key controller includes key information which specifies the type of a key valid for execution of application by the CPU and notification information which specifies notification style to the interruption controller for each key, a key control unit which sets key information and notification information corresponding to the application which the CPU executes in a register of the key controller and notifies generation of key interruption corresponding to key operation based on the set information to the interruption controller and a buffer which memorizes information about type and operation style indicated by a key signal from the key button,

the key control unit compares memory capacity necessary for information to be stored in the buffer with the amount of space in the buffer and if the amount of space in the buffer is smaller, aborts the information; if notification of a key interruption when the key is released after it is pressed is set as notification information corresponding to the key signal, which indicates that the key is pressed and is to be stored in the buffer, the key control unit retains notification of key interruption relating to the key until the key signal indicating a release of the key is stored into the buffer; and the key control unit notifies the sound control unit of generation of key interruption,

the sound control unit transmitting an acoustic signal triggered by a notification from the key control unit,

execute a step of, when a key operation interruption signal is received from the interruption controller, reading out key read data containing information stored in the buffer from the register and notifying the application of generation of the key event based on the read out key read data; and a step of specifying stopping notification from the key controller to the interruption controller in the register during switch of the applications.

(14) A computer program product which makes a CPU of an embedded system comprising: a key button which user operates; CPU which executes an application; an interruption controller which supplies a key operation interruption signal to the CPU; a key controller for notifying the interruption controller of generation of a key interruption based on a key signal indicating a status change of the key button; a speaker; and a sound control unit for dispatching an acoustic signal to the speaker, wherein

the key controller includes key information which specifies the type of a key valid for execution of application by the CPU and notification information which specifies notification style to the interruption controller for each key, a key control unit which sets key information and notification information corresponding to the application which the CPU executes in a register of the key controller and notifies generation of key interruption corresponding to key operation based on the set information to the interruption controller, a buffer which memorizes information about type and operation style indicated by a key signal from the key button and a key control timer for timekeeping and

the key control unit compares memory capacity necessary for information to be stored in the buffer with the amount of space in the buffer and if the amount of space in the buffer is smaller, aborts the information; if long period key pressing which keeps the key pressed in a predetermined period based on the timekeeping of the key control timer is set as a key information corresponding to a key signal, which indicates that the key is pressed and is to be stored in the buffer, the key control unit sets the predetermined period in the key control timer and stores information indicating that the long period key pressing is valid when it is notified that the key control timer expires before the key signal indicating release of the key is stored into the buffer; and the key control unit notifies the sound control unit of generation of key interruption,

the sound control unit transmitting an acoustic signal triggered by a notification from the key control unit,

execute a step of, when a key operation interruption signal is received from the interruption controller, reading out key read data containing information stored in the buffer from the register and notifying the application of generation of the key event based on the read out key read data; and a step of specifying stopping notification from the key controller to the interruption controller in the register during switch of the applications.

(15) A computer program product which makes a CPU of an embedded system comprising: a key button which user operates; CPU which executes an application; an interruption controller which supplies a key operation interruption signal to the CPU; a key controller for notifying the interruption controller of generation of a key interruption based on a key signal indicating a status change of the key button; a speaker; and a sound control unit for dispatching an acoustic signal to the speaker, wherein

the key controller includes key information which specifies the type of a key valid for execution of application by the CPU and notification information which specifies notification style to the interruption controller for each key, a key control unit which sets key information and notification information corresponding to the application which the CPU executes in a register of the key controller and notifies generation of key interruption corresponding to key operation based on the set information to the interruption controller, a buffer which memorizes information about type and operation style indicated by a key signal from the key button and a key control timer for timekeeping and,

the key control unit compares memory capacity necessary for information to be stored in the buffer with the amount of space in the buffer and if the amount of space in the buffer is smaller, aborts the information; if notification of a key interruption when the key is released after it is pressed is set as notification information corresponding to the key signal, which indicates that the key is pressed and is to be stored in the buffer, the key control unit retains notification of key interruption relating to the key until the key signal indicating a release of the key is stored into the buffer; if long period key pressing which keeps the key pressed in a predetermined period based on the timekeeping of the key control timer is set as a key information corresponding to a key signal, which indicates that the key is pressed and is to be stored in the buffer, the key control unit sets the predetermined period in the key control timer and stores information indicating that the long period key pressing is valid when it is notified that the key control timer expires before the key signal indicating release of the key is stored into the buffer; and the key control unit notifies the sound control unit of generation of key interruption,

the sound control unit transmitting an acoustic signal triggered by a notification from the key control unit,

execute a step of, when a key operation interruption signal is received from the interruption controller, reading out key read data containing information stored in the buffer from the register and notifying the application of generation of the key event based on the read out key read data; and a step of specifying stopping notification from the key controller to the interruption controller in the register during switch of the applications.

(16) The computer program product described in the preceding paragraph (7) which makes the CPU executes a step of when the switch of applications finished, instructing the key control unit to set key information and notification information corresponding to activated application in the register of the key controller, reading key read data from the register, determining whether or not any information exists in the buffer based on the key read data and if there is not information in the buffer, and specifying releasing of stop of the notification to the interruption controller from the key controller.

(17) The computer program product described in the preceding paragraph (8) which makes the CPU executes a step of when the switch of applications finished, instructing the key control unit to set key information and notification information corresponding to activated application in the register of the key controller, reading key read data from the register, determining whether or not any information exists in the buffer based on the key read data and if there is not information in the buffer, and specifying releasing of stop of the notification to the interruption controller from the key controller.

(18) The computer program product described in the preceding paragraph (9) which makes the CPU executes a step of when the switch of applications finished, instructing the key control unit to set key information and notification information corresponding to activated application in the register of the key controller, reading key read data from the register, determining whether or not any information exists in the buffer based on the key read data and if there is not information in the buffer, and specifying releasing of stop of the notification to the interruption controller from the key controller.

(19) The computer program product described in the preceding paragraph (10) which makes the CPU executes a step of when the switch of applications finished, instructing the key control unit to set key information and notification information corresponding to activated application in the register of the key controller, reading key read data from the register, determining whether or not any information exists in the buffer based on the key read data and if there is not information in the buffer, and specifying releasing of stop of the notification to the interruption controller from the key controller.

(20) The computer program product described in the preceding paragraph (11) which makes the CPU executes a step of when the switch of applications finished, instructing the key control unit to set key information and notification information corresponding to activated application in the register, of the key controller reading key read data from the register, determining whether or not any information exists in the buffer based on the key read data and if there is not information in the buffer, and specifying releasing of stop of the notification to the interruption controller from the key controller.

(21) The computer program product described in the preceding paragraph (12) which makes the CPU executes a step of when the switch of applications finished, instructing the key control unit to set key information and notification information corresponding to activated application in the register of the key controller, reading key read data from the register, determining whether or not any information exists in the buffer based on the key read data and if there is not information in the buffer, and specifying releasing of stop of the notification to the interruption controller from the key controller.

(22) The computer program product described in the preceding paragraph (13) which makes the CPU executes a step of when the switch of applications finished, instructing the key control unit to set key information and notification information corresponding to activated application in the register of the key controller, reading key read data from the register, determining whether or not any information exists in the buffer based on the key read data and if there is not information in the buffer, and specifying releasing of stop of the notification to the interruption controller from the key controller.

(23) The computer program product described in the preceding paragraph (14) which makes the CPU executes a step of when the switch of applications finished, instructing the key control unit to set key information and notification information corresponding to activated application in the register of the key controller, reading key read data from the register, determining whether or not any information exists in the buffer based on the key read data and if there is not information in the buffer, and specifying releasing of stop of the notification to the interruption controller from the key controller.

(24) The computer program product described in the preceding paragraph (15) which makes the CPU executes a step of when the switch of applications finished, instructing the key control unit to set key information and notification information corresponding to activated application in the register of the key controller, reading key read data from the register, determining whether or not any information exists in the buffer based on the key read data and if there is not information in the buffer, and specifying releasing of stop of the notification to the interruption controller from the key controller.

(25) The computer program product described in the preceding paragraph (7) which makes the CPU execute a step of when the switch of applications finished, setting key information and notification information corresponding to activated application in the register of the key controller, instructing the key control unit to delete information in the buffer and specifying release of stop of the notification to the interruption controller from the key controller after the instruction.

(26) The computer program product described in the preceding paragraph (8) which makes the CPU execute a step of when the switch of applications finished, setting key information and notification information corresponding to activated application in the register of the key controller, instructing the key control unit to delete information in the buffer and specifying release of stop of the notification to the interruption controller from the key controller after the instruction.

(27) The computer program product described in the preceding paragraph (9) which makes the CPU execute a step of when the switch of applications finished, setting key information and notification information corresponding to activated application in the register of the key controller, instructing the key control unit to delete information in the buffer and specifying release of stop of the notification to the interruption controller from the key controller after the instruction.

(28) The computer program product described in the preceding paragraph (10) which makes the CPU execute a step of when the switch of applications finished, setting key information and notification information corresponding to activated application in the register of the key controller, instructing the key control unit to delete information in the buffer and specifying release of stop of the notification to the interruption controller from the key controller after the instruction.

(29) The computer program product described in the preceding paragraph (11) which makes the CPU execute a step of when the switch of applications finished, setting key information and notification information corresponding to activated application in the register of the key controller, instructing the key control unit to delete information in the buffer and specifying release of stop of the notification to the interruption controller from the key controller after the instruction.

(30) The computer program product described in the preceding paragraph (12) which makes the CPU execute a step of when the switch of applications finished, setting key information and notification information corresponding to activated application in the register of the key controller, instructing the key control unit to delete information in the buffer and specifying release of stop of the notification to the interruption controller from the key controller after the instruction.

(31) The computer program product described in the preceding paragraph (13) which makes the CPU execute a step of when the switch of applications finished, setting key information and notification information corresponding to activated application in the register of the key controller, instructing the key control unit to delete information in the buffer and specifying release of stop of the notification to the interruption controller from the key controller after the instruction.

(32) The computer program product described in the preceding paragraph (14) which makes the CPU execute a step of when the switch of applications finished, setting key information and notification information corresponding to activated application in the register of the key controller, instructing the key control unit to delete information in the buffer and specifying release of stop of the notification to the interruption controller from the key controller after the instruction.

(33) The computer program product described in the preceding paragraph (15) which makes the CPU execute a step of when the switch of applications finished, setting key information and notification information corresponding to activated application in the register of the key controller, instructing the key control unit to delete information in the buffer and specifying release of stop of the notification to the interruption controller from the key controller after the instruction.

(34) A key controller connected to a key button operated by user and an interruption controller for supplying a key operation interruption signal to a CPU executing an application, the key controller comprising:

a determining circuit for executing chattering determination of a key signal indicating a status change of the key button; and

a register circuit holding data indicating the type of a key valid to an application being executed, wherein

the determining circuit has a means for determining whether or not the chattering determination about the key signal from the key button is scheduled to be executed based on data from the register circuit.

(35) A key interruption control method in which a key controller connected to a key button operated by user and an interruption controller for supplying a key operation interruption signal to a CPU executing an application

has a key table containing: key information which specifies the key type and operation style valid to execution of the application by the CPU; and notification information which specifies the notification style to the interruption controller for each key,

the key interruption control method comprising setting key information and notification information corresponding to an application which the CPU executes in the register of the key controller of the key controller; and notifying the interruption controller of generation of a key interruption corresponding to key operation based on the set information.

(36) The key interruption control method described in the preceding paragraph (35) wherein, the key controller

has a buffer which memorizes information about the type and operation style indicated by a key signal from the key button; and

compares a memory capacity necessary for information to be stored in the buffer with the amount of space in the buffer and if the amount of space in the buffer is small, aborts the information.

(37) The key interruption control method described in the preceding paragraph (36) wherein,

if notification of key interruption when the key is released after it is pressed is set as notification information corresponding to the key signal, which indicates that the key is pressed and is to be stored in the buffer, the key controller retains notification of key interruption relating to the key until the key signal indicating a release of the key is stored in the buffer.

(38) The key interruption control method described in the preceding paragraph (36) wherein,

the key controller has a key control timer for timekeeping,

if long period key pressing which keeps the key pressed in a predetermined period based on the timekeeping of the key control timer is set as key information corresponding to a key signal, which indicates that the key is pressed and is to be stored in the buffer, the key controller sets the predetermined period in the key control timer and stores information indicating that the long period key pressing is valid when it is notified that the key control timer expires before a key signal indicating a release of the key is stored in the buffer.

(39) The key interruption control method described in the preceding paragraph (37) wherein,

the key controller has a key control timer for timekeeping,

if long period key pressing which keeps the key pressed in a predetermined period based on the timekeeping of the key control timer is set as key information corresponding to a key signal, which indicates that the key is pressed and is to be stored in the buffer, the key controller sets the predetermined period in the key control timer and stores information. indicating that the long period key pressing is valid when it is notified that the key control timer expires before a key signal indicating a release of the key is stored in the buffer.

(40) An embedded system comprising: a key button which user operates; a CPU which executes an application; an interruption controller which supplies a key operation interruption signal to the CPU; and a key controller for notifying the interruption controller of generation of a key interruption based on a key signal indicating a status change of the key button, wherein

the key controller includes

a key table containing key notification information of each key which specifies a key type and operation style valid to execution of application by the CPU and notification information which specifies the notification style of interruption to the key operation to the interruption controller for each key and

a key control unit which sets key information and notification information corresponding to the application, which the CPU executes, in a register of the key controller and notifies the interruption controller of generation of key interruption corresponding to key operation based on the set information.

(41) The embedded system described in the preceding paragraph (40) wherein the key controller includes a buffer which memorizes key operation information notified from the key button, and

the key controller compares memory capacity necessary for key operation information to be stored in the buffer with the amount of space in the buffer based on the key table when detecting that the key is pressed from the key signal of the key button and if the amount of space in the buffer is smaller, aborts the operation information of the key until release of the key is detected.

(42) The embedded system described in the preceding paragraph (40) wherein if notification of key interruption when the key is released after it is pressed is set as an operation style of the key in the key table when the key controller detects that the key is pressed from the key signal from the key button, the key controller retains the key interruption notification relating to the key when the key is pressed and notifies of the key interruption when release of the key is accepted.

(43) The embedded system described in the preceding paragraph (41) wherein the key controller includes a timer for key control,

if long period key pressing which detects continuously pressing of the key in a predetermined period based on the timer is specified to be valid as an operation style relating to the key in the key table when the key controller detects that the key is pressed from a key signal form the key button, the key controller sets the predetermined period in the timer and when expiration of the period is notified from the timer before release of the key is detected, the key controller determines that the long period key pressing of the key is valid, stores information of the long period key pressing in the buffer and notifies the interruption controller of an interruption request.

(44) A computer program product which makes the CPU of the embedded system, comprising: a key button which user operates; a CPU which executes an application; an interruption controller which supplies a key operation interruption signal to the CPU; and a key controller for notifying the interruption controller of generation of a key interruption based on a key signal indicating a status change of the key button, wherein

the key controller includes a key table containing key notification information of each key which specifies a key type and operation style valid to execution of application by the CPU and notification information which specifies the notification style of interruption to the key operation for each key to the interruption controller and a key control unit which sets key information and notification information corresponding to the application, which the CPU executes, in a register of the key controller and notifies the interruption controller of generation of key interruption corresponding to key operation based on the set information, and a buffer which memorizes key operation information notified from the key button,

the key controller compares memory capacity necessary for key operation information to be stored in the buffer with the amount of space in the buffer based on the key table when detecting that the key is pressed from the key signal of the key button and if the amount of space in the buffer is smaller, aborts the operation information of the key until release of the key is detected,

execute a step of, if application switch request is generated when a plurality of applications are activated, masking notification of key interruption from the key controller into the interruption controller; and a step of releasing the mask of notification of interruption from the key controller into the interruption controller after the switch of applications finishes.

(45) A computer program product which makes the CPU of the embedded system, comprising: a key button which user operates; CPU which executes an application; an interruption controller which supplies a key operation interruption signal to the CPU; and a key controller for notifying the interruption controller of generation of a key interruption based on a key signal indicating a status change of the key button, wherein

the key controller includes a key table containing key notification information of each key which specifies a key type and operation style valid to execution of application by the CPU and notification information which specifies the notification style of interruption to the key operation for each key to the interruption controller and a key control unit which sets key information and notification information corresponding to the application, which the CPU executes, in a register of the key controller and notifies the interruption controller of generation of key interruption corresponding to key operation based on the set information,

if notification of key interruption when the key is released after it is pressed is set as an operation style of the key in the key table when the key controller detects that the key is pressed from the key signal from the key button, the key controller retains the key interruption notification relating to the key when it is pressed and notifies of the key interruption when release of the key is accepted,

execute a step of if application switch request is generated when a plurality of applications are activated, masking notification of key interruption from the key controller into the interruption controller; and a step of releasing the mask of notification of interruption from the key controller into the interruption controller after the switch of applications finishes.

(46) A computer program product which makes the CPU of the embedded system, comprising: a key button which user operates; a CPU which executes an application; an interruption controller which supplies a key operation interruption signal to the CPU; and a key controller for notifying the interruption controller of generation of a key interruption based on a key signal indicating a status change of the key button, wherein

the key controller includes a key table containing key notification information of each key which specifies a key type and operation style valid to execution of application by the CPU and notification information which specifies the notification style of interruption to the key operation for each key to the interruption controller and a key control unit which sets key information and notification information corresponding to the application, which the CPU executes, in a register of the key controller and notifies the interruption controller of generation of key interruption corresponding to key operation based on the set information, a buffer which memorizes key operation information notified from the key button, and a timer for key control,

the key controller compares memory capacity necessary for key operation information to be stored in the buffer with the amount of space in the buffer based on the key table when detecting that the key is pressed from the key signal of the key button and if the amount of space in the buffer is smaller, aborts the operation information of the key until release of the key is detected, and if long period key pressing which detects continuously pressing of the key in a predetermined period based on the timer is specified to be valid as an operation style relating to the key in the key table when the key controller detects that the key is pressed from a key signal form the key button, the key controller sets the predetermined period in the timer and when expiration of the period is notified from the timer before release of the key is detected, the key controller determines that the long period key pressing of the key is valid, stores information of the long period key pressing in the buffer and notifies the interruption controller of an interruption request,

execute a step of, if application switch request is generated when a plurality of applications are activated, masking notification of key interruption from the key controller into the interruption controller; and a step of releasing the mask of notification of interruption from the key controller into the interruption controller after the switch of applications finishes.

(47) The computer program product described in the preceding paragraph (44) which makes the CPU execute a step of,

when the applications are switched, setting whether or not the application, which is activated after the switching, uses data held in the buffer of the key controller in the key controller as information of the key table and deleting the data in the buffer before the interruption notification is released if deletion of data held in the buffer at the time of application switch is specified based on information of the key table.

(48) The computer program product described in the preceding paragraph (45) which makes the CPU execute a step of,

when the applications are switched, setting whether or not the application, which is activated after the switching, uses data held in the buffer of the key controller in the key controller as information of the key table and deleting the data in the buffer before the interruption notification is released if deletion of data held in the buffer at the time of application switch is specified based on information of the key table.

(49) The computer program product described in the preceding paragraph (46) which makes the CPU execute a step of,

when the applications are switched, setting whether or not the application, which is activated after the switching, uses data held in the buffer of the key controller in the key controller as information of the key table and deleting the data in the buffer before the interruption notification is released if deletion of data held in the buffer at the time of application switch is specified based on information of the key table.

According to the present invention, determination about key interruption can be made unlikely to be affected by load condition of the CPU because the embedded system determines whether or not key interruption occurs on the key controller side. Further, because the key controller determines whether or not the key interruption occurs based on the information corresponding to an application currently being executed, waste processing of for example, accepting a key operation not corresponding to the application currently being executed can be blocked.

### BRIEF DESCRIPTION OF THE DRAWINGS

FIG. 1 is a block diagram showing the hardware configuration of a portable information terminal according to an embodiment of the present invention;

FIG. 2 is a block diagram showing the hardware configuration of a conventional portable information terminal;

FIG. 3 is a flow chart showing the control procedure of a key controller (KC) when a key is pressed, according to the embodiment;

FIG. 4 is a flow chart showing the control procedure of the key controller (KC) when the key is released, according to the embodiment;

FIG. 5 is a flow chart showing the control procedure of the key controller (KC) when the key is pressed in a long period according to the embodiment;

FIG. 6 is a flow chart showing the control procedure of software of the embodiment;

FIG. 7 is a flow chart showing the control procedure of middleware of the embodiment;

FIG. 8 is a flow chart showing the control procedure by the middleware when the application is changed over, according to the embodiment;

FIG. 9 is a block diagram showing the configuration of conventional software;

FIG. 10 is an explanatory diagram of the format of key read data of the embodiment;

FIG. 11 is a block diagram showing the configuration of a portable information terminal according to other embodiment of the present invention;

FIG. 12 is a flow chart of conventional chattering determination; and

FIG. 13 is a circuit diagram for the chattering determination of the embodiment.

### DESCRIPTION OF THE PREFERRED EMBODIMENTS

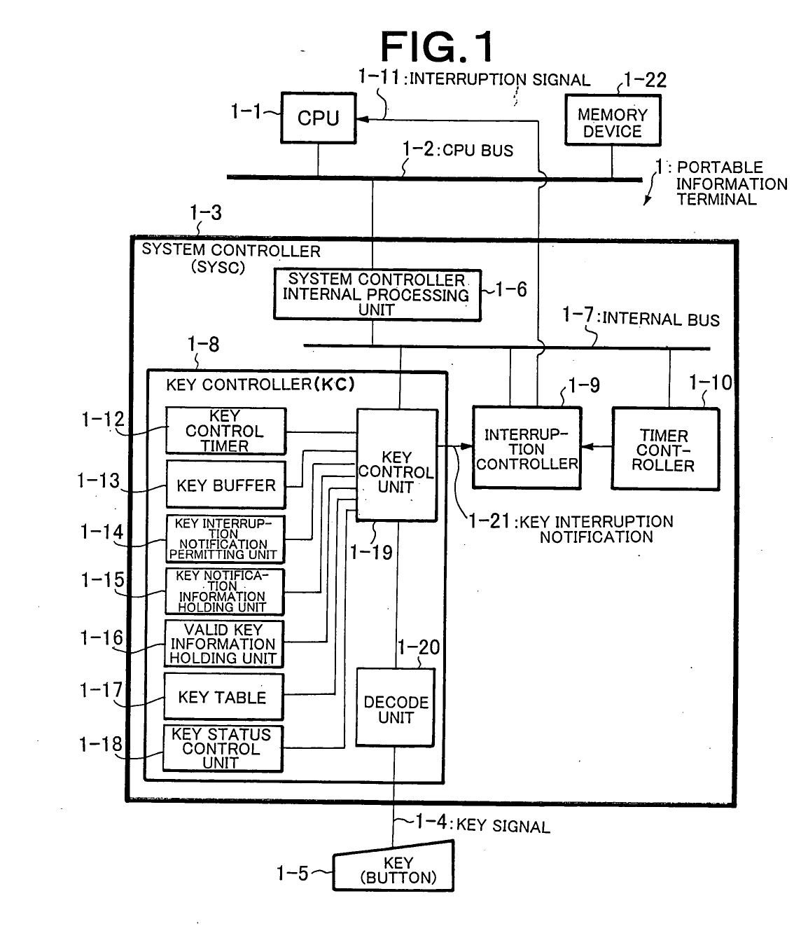

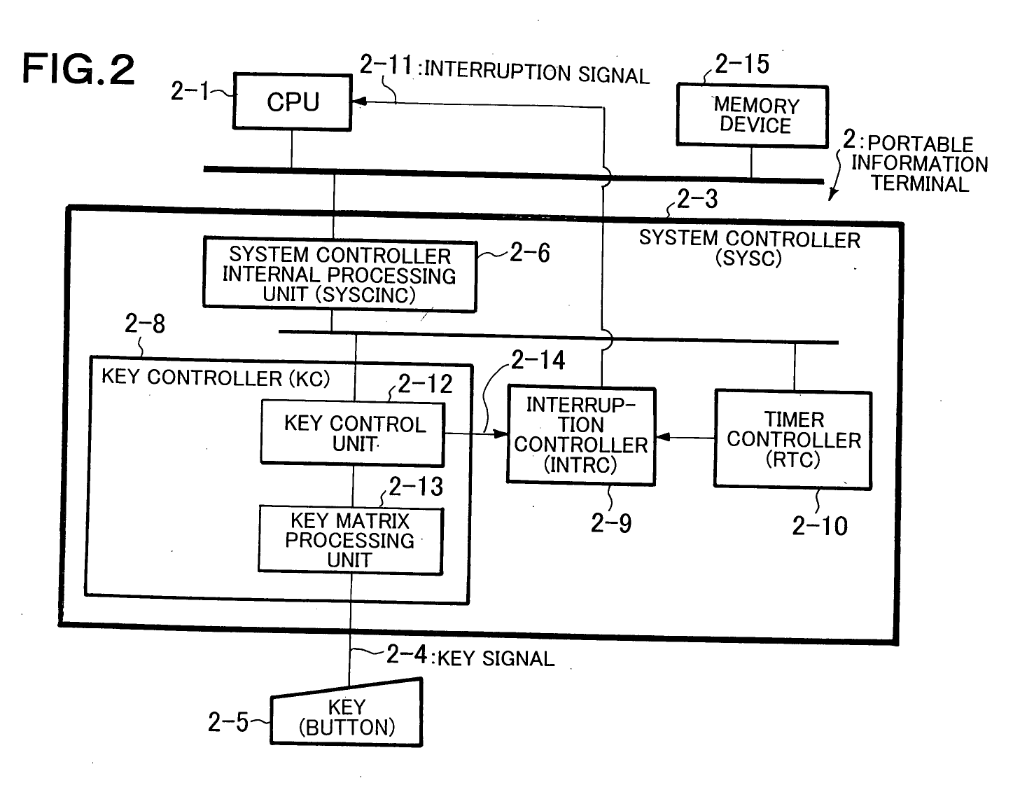

Hereinafter, the preferred embodiment of the present invention will be described in detail with reference to the accompanying drawings. FIG. 1 is a block diagram of hardware configuration relating to key control in a portable information terminal 1 of this embodiment. In the portable information terminal 1, as shown in FIG. 1, CPU1-1 which is central processing unit, memory device 1-22 which holds a program to be executed with the CPU1-1 and system controller (hereinafter referred to as SYSC) containing key controller (hereinafter referred to as KC) 1-8 are connected through CPU bus 1-2. In the meantime, although the memory bus 1-22 is connected to the CPU bus 1-2 in the indicated example, this embodiment is not restricted to this connection style but it may be provided within the SYSC 1-3.

In the portable information terminal 1 in FIG. 1, a state change of a key button 1-5 is notified to the SYSC 1-3 which is system LSI through a key signal 1-4 like a key matrix signal from the key button 1-5 and after that, it is notified to the CPU 1-1 through an interruption signal 1-11 through interanal processing from this SYSC 1-3.

The SYSC 1-3 includes KC 1-8, interruption controller (hereinafter referred to as INTRC)1-9, timer controller (hereinafter referred to as RTC) 1-10 which is a system timer used by the CPU 1-1, and system controller internal processing unit (hereinafter referred to as SYSCINC) which controls read/write in registers having a variety of functions. These are connected to each other in the SYSC 1-3 through internal bus 1-7. The RTC 1-10 notifies of an interruption of timer event each time when a specified time elapses.

The KC 1-8 includes a decode unit 1-20 for specifying a key signal 1-4 from the key button 1-5, a key control timer 1-12 which has clock output function for use in chattering determination of key operation and timer function for determination about long period key pressing, a key buffer 1-13 which holds key operation information and has function of erasing the internal data and a key control unit 1-19 which processes the key control integrally.

A key table 1-17 possessed by the KC 1-8 includes notification information (notification of key pressing when it is pressed and notification of key pressing when it is released) specified for each key, key information about the type of effective key specified for each application and its operation status, information about whether information left in the key buffer 1-13 should be aborted when an application is changed over and the like.

The KC 1-8 includes a key interruption notification permitting unit 1-14 which holds information indicating whether or not key interruption notification to the INTRC 1-9 is permitted, key notification information holding unit 1-15 which holds notification information corresponding to an application currently being executed, an valid key information holding unit 1-16 which holds information about the type of an effective key for the application currently being executed and its operation condition and a key status control unit 1-18 which stores information about status from key pressing to key release. The configuration of these components (1-14, 1-15, 1-16, 1-18) indicates the register unit of the KC 1-8 in which corresponding information is set.

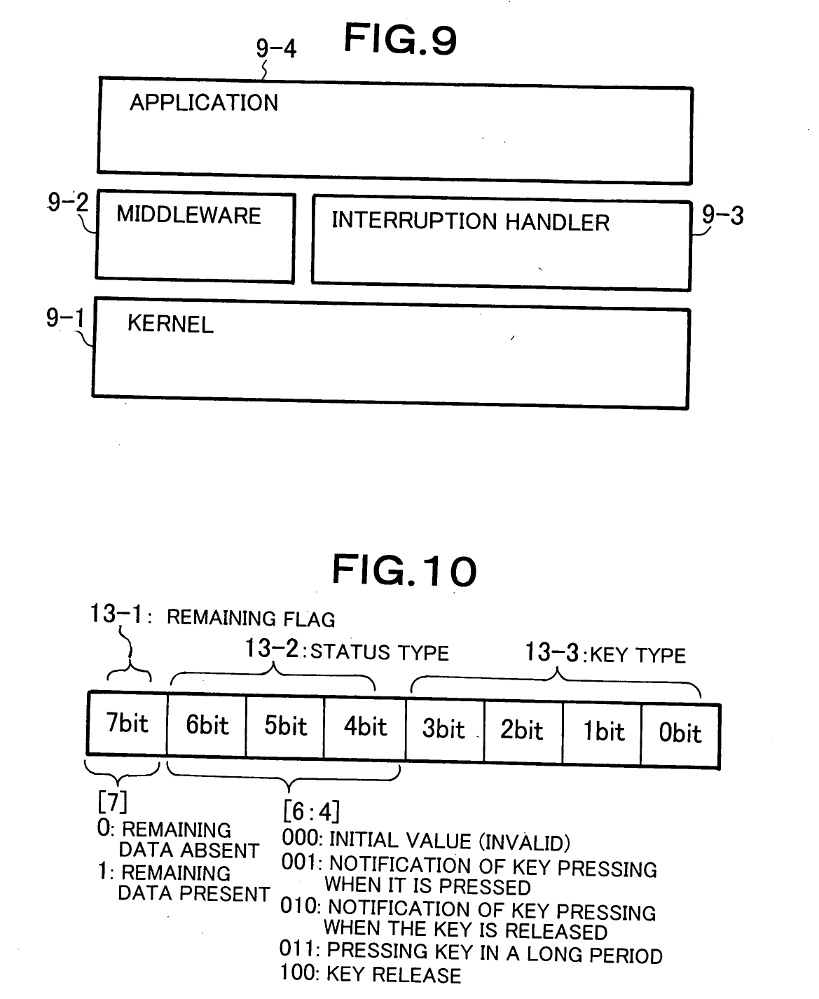

The software configuration of this embodiment, that is, the configuration of software which is executed by the CPU 1-1 is the same as the conventional configuration described with FIG. 9. If the basic processing procedure by software is explained here, when the CPU 1-1 detects an interruption with an interruption signal 1-11, the interruption handler reads an interruption factor register of the INRTC 1-9. Consequently, a handler corresponding to the interruption factor is executed. In this embodiment, the handler in which an interruption factor is a key operation is called key interruption handler.

The key interruption handler can read data from the key buffer 1-13 through the key control unit 1-19 and execute read/write to registers having a variety of functions within the KC 1-8. Additionally, the middleware of this embodiment can execute read/write to the registers in the KC 1-8 like the above-mentioned key interruption handler.

In the read/write of the key table 1-17, the valid key information holding unit 1-16 and the key notification information holding unit 1-15, data write time at the time of application switch can be shortened according to memory map register method, that is, by adopting a method of reading/writing data on a memory address which is mapped on a physical memory as non-cacheable (non cache control object).

Preferably, setting of the key table 1-17 is executed at the time of initialization when the power of the portable information terminal 1 is turned ON or the table is stored in a ROM. As a consequence, when the application is changed over, the key information and valid key information can be updated by writing only a difference from the CPU 1-1 without rewriting all the key information and valid key information.

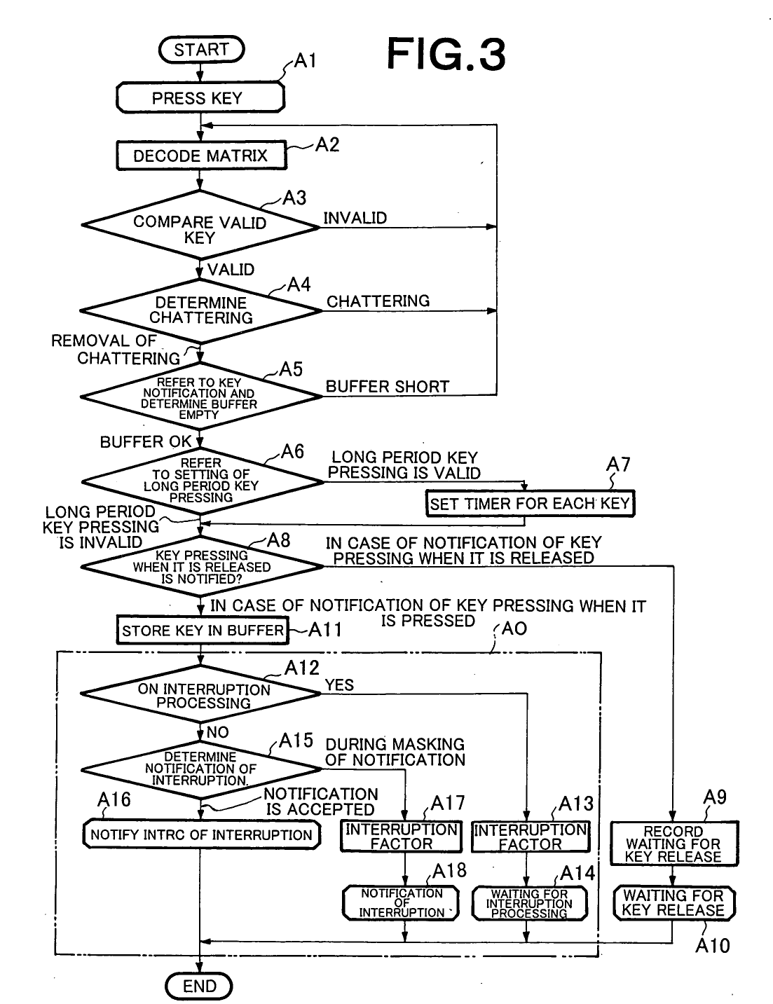

A procedure in which the interruption is notified from the KC 1-8 to the INTRC 1-9 when user presses the key button 1-5 will be described with reference to the flow chart of FIG. 3. Information corresponding to an application currently being executed is set in the key information holding unit 1-15 and the valid key information holding unit 1-16 of the KC 1-8. This means that the information existing on the key table 1-17 is set in the register of the KC 1-8.

If the key signal 1-4 is outputted to the KC 1-8 when user presses the key button 1-5 (step Al), the key control unit 1-19 recognizes an input of the key signal 1-4 through the decode unit 1-20 and specifies a key corresponding to the key signal 1-4 based on the key table 1-17 (step A2). Assume that the key in which a status change occurs is key A.

When the key A is recognized, the key control unit 1-19 determines whether the key A is set to be valid in the valid key information holding unit 1-16 (step A3). If the key A is not valid, that is, the key A does not correspond to the application currently being executed, following processing is not executed.

On the other hand, when the key A is set to be valid, the key control unit 1-19 acquires a sample CLK (clock) for chattering determination from the key control timer 1-12 so as to execute the chattering determination processing (step A4). In the chattering determination processing, this key signal 1-4 is stored as the key signal from which the chattering is removed when the key signal 1-4 of the key A is determined to be valid based on the sample CLK.

The key control unit 1-19 inputs the key signal of the key A from which the chattering is removed into the key notification information holding unit 1-15 so as to acquire information indicating the maximum value of a capacity necessary for storing this key signal into the key buffer 1-13. For example, if long period key pressing notification is set in the key A in the key notification information holding unit 1-15, the key control unit 1-19 acquires data amount including information indicating the long period key pressing of the key A as the maximum value.

The key control unit 1-19 compares the maximum value acquired from the key notification information holding unit 1-15 with the amount of space in the key buffer 1-13 (step A5). If the amount of space in the key buffer 1-13 is larger than the maximum value as a result of the comparison, pressing of the key A is accepted and information indicating a status that the key A is pressed is held in he key status control unit 1-18. This information is cleared after release of the key A is accepted. If the amount of space in the key buffer 1-13 is smaller than the maximum value, the key signal 1-4 is aborted so as to invalidate the pressing of the key A. This can prevent malfunction from occurring because user's operation is not stored sufficiently in the buffer as the amount of space in the key buffer 1-13 is short upon key operation.

When pressing of the key A is accepted, the key control unit 1-19 determines whether or not long period key pressing notification is set to be valid to the current key A by referring to the long period control information about the key A from the key notification information holding unit 1-15 (step A6). If the long period key pressing notification is set to be valid to the key A, a long period pressing determination time of the key A is set in the key control timer 1-12 and timer processing of the key control timer 1-12 is started (step A7). In the meantime, internal consumption power of the key control timer 1-12 when the timer is not used can be reduced by setting the key control timer 1-12 to activate the internal counter when it receives a start signal from the key control unit 1-19.

Subsequently, the key control unit 1-19 determines whether the notification of key pressing when it is pressed is set in the key A by referring to notification information about the key A from the key notification information holding unit 1-15 (step A8). If the notification of key pressing when it is released is set, that is, the pressing of the key is set to be recognized by the operation of releasing the key, the key control unit 1-19 records information indicating that the key A is waiting for being released in the key status control unit 1-18 without executing the key interruption notification 1-21 to the INTRC 1-9 (step A9) and waits for the key A to be released (step A10).

If the notification of key pressing when it is released is set in a pressed key in this way, the interruption signal of the key pressing is not notified to the CPU 1-1 because the key interruption notification 1-21 is not transmitted. Consequently, waste processing is reduced thereby reducing a load on the CPU 1-1.

On the other hand, if the notification of key pressing when it is pressed is set up instead of the notification of key pressing when it is released in the notification information of the key A, the key control unit 1-19 stores information indicating the pressing of the key A in the key buffer 1-13 (step A11).

Further, the key control unit 1-19 determines whether or not the interruption processing about the key operation is carried out currently on the CPU 1-1 with reference to the value of the key status control unit 1-18 (step A12). If other interruption processing is carried out as a result, the key control unit 1-19 waits for read processing from a register by that interruption processing to end (steps A13, A14).

On the other hand, unless the interruption processing is currently executed, the key control unit 1-19 determines whether or not permission of key interruption notification to the key A is set up with reference to the key interruption notification permitting unit 1-14 (step A15). Setting of the key interruption notification permitting unit 1-14 is executed by the middleware of the CPU 1-1. This setting will be described later and while the application is being changed over on the CPU 1-1, masking or retention of new key interruption notification 1-21 to the INTRC 1-9 is set in the key interruption notification permitting unit 1-14.

If the key interruption notification is currently permitted, the key control unit 1-19 executes the key interruption notification 1-21 to the INTRC 1-9 (step A16). As a result, after receiving the key interruption notification 1-21, the INTRC 1-9 transmits the interruption signal 1-11 to the CPU 1-1. Further, if the key interruption notification is not permitted or masked, the key interruption notification 1-21 to the INTRC 1-9 is carried out when the mask is released (steps A17, A18).

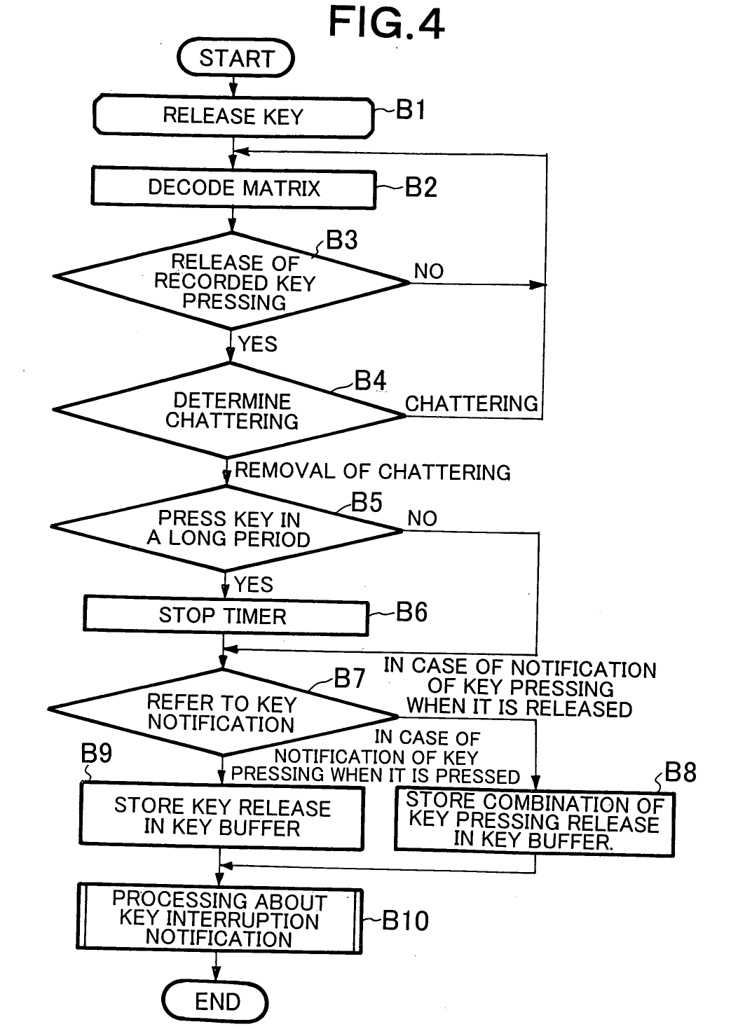

The control procedure at the time of key release will be described with reference to the flow chart of FIG. 4. The control procedure when the already pressed key A is released will be described. If a key signal is inputted to the KC 1-8 when user's hand leaves the key A of the key button 1-5 (step Bi), the key control unit 1-19 recognizes a release of the key A based on output of the decode unit 1-20 (step B2).

The key control unit 1-19 determines whether or not a recognized key release action is release to pressing of the key recorded in the key status control unit 1-18 (step B3). If it is the release action to the pressing of the key, the key control unit 1-19 executes the same chattering determination on this release action as described previously.

When the key signal 1-4 passes the chattering determination, the key control unit 1-19 determines whether or not the long period key pressing is set on a target key A based on recording of the key status control unit 1-18 (step B5) and if the long period key pressing is set, the key control timer which is actuating a timer for the long period key pressing determination is stopped (step B6).

Next, the key control unit 1-19 determines whether the notification of key pressing when it is pressed or the notification of key pressing when it is released is set in the target key A based on recording of the key status control unit 1-18 (step B7). If the notification of key pressing when it is released is set in the key A as a result, information of pressing of the key A and information of release of the key A are stored in the key buffer 1-13 by the set (step B8).

When the notification of key pressing when it is pressed is set up, only information of release of the key A is stored because information of pressing of the key A is already stored (step B9). Processing of the interruption notification after data of the key A is stored in the key buffer 1-13 (step B10) is the same as the above-described procedure (A0) indicated with a dotted line in FIG. 3 and description thereof is omitted.

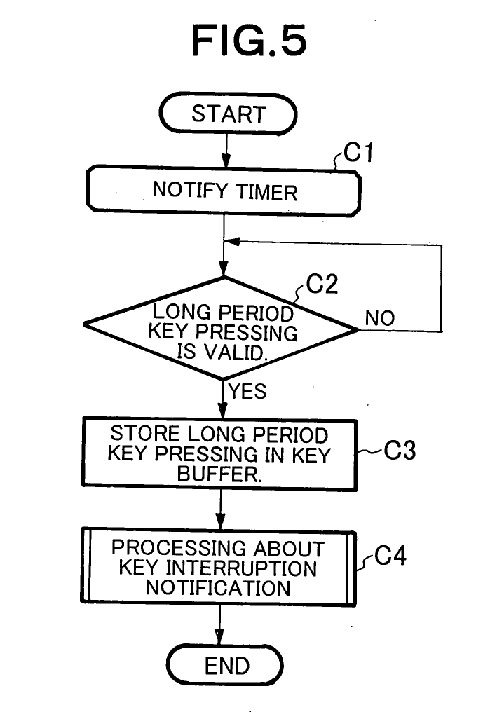

Control procedure about the long period key pressing will be described with reference to the flow chart of FIG. 5. Assume that for the key A in which the long period key pressing is set validly, the key control timer 1-12 is already started (FIG. 3: step A6 - A7). In the meantime, the key control timer 1-12 of the KC 1-8 is actuated independently of the processing of the CPU 1-1. Thus, the key control timer 1-12 is not affected by the action of the CPU 1-1.

The key control unit 1-19 synchronizes an expiration notification from the key control timer 1-12 with the release notification of the key A which passes the above-described chattering determination with an operation reference CLK. If the expiration of the timer and the release of the key A are notified simultaneously, the notification of the key release is taken as preference. There is no problem in taking the key release as preference with a difference of a cycle because the frequency of the operation reference CLK (clock of a value near about 100 ms created by dividing for example, 32 KHz).

The key control unit 1-19 determines whether or not the long period key pressing of the key A is valid (step C2) according to information of the key A of the key status control unit 1-18 when it is notified that a period corresponding to the long period pressing has elapsed (step C1).

If waiting for the key A to be released is set in the key status control unit 1-18 upon determining of the long period key pressing, it is determined that the long period pressing is valid and in this case, information indicating the key A is pressed in a long period is stored in the key buffer 1-13 (step C3). Unless waiting for the key A to be released is set up, the long period pressing is processed as invalid. The processing about following interruptions (step C4) is the same as the above-described procedure (AO) indicated with a dotted line in FIG. 3 and description thereof is omitted. If the release of the key A is received before the timer relating to the long period pressing expires, the circuit of the timer processing is initialized when the release is received.

If the determination of the long period pressing of the key is carried out on the KC 1-8, the long period pressing can be determined appropriately without being affected by load condition of the CPU 1-1.

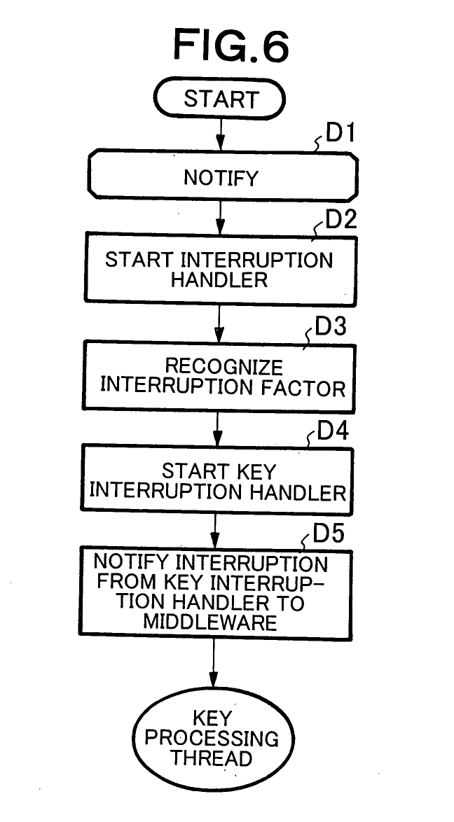

The procedure until the operation of the key button 1-5 is notified to the CPU 1-1 has been described above. Next, how the interruption processing notified to the CPU 1-1 is processed with software which executes the CPU 1-1 will be described with flow charts of FIGS. 6, 7, 8. In the meantime, the configuration of the software which the CPU 1-1 executes is the same as the configuration shown in FIG. 9.

If the CPU 1-1 receives an interruption from the SYSC 1-3 in FIG. 6 (step D1), the kernel starts the interruption handler (step D2). The interruption handler reads the interruption factor register of the INTRC 1-9 in order to determine the interruption factor. If the interruption factor is key control as a result (step D3), the interruption handler for the key control is executed (step D4). The key interruption handler notifies the middleware that a status change of the key occurs (step D5).

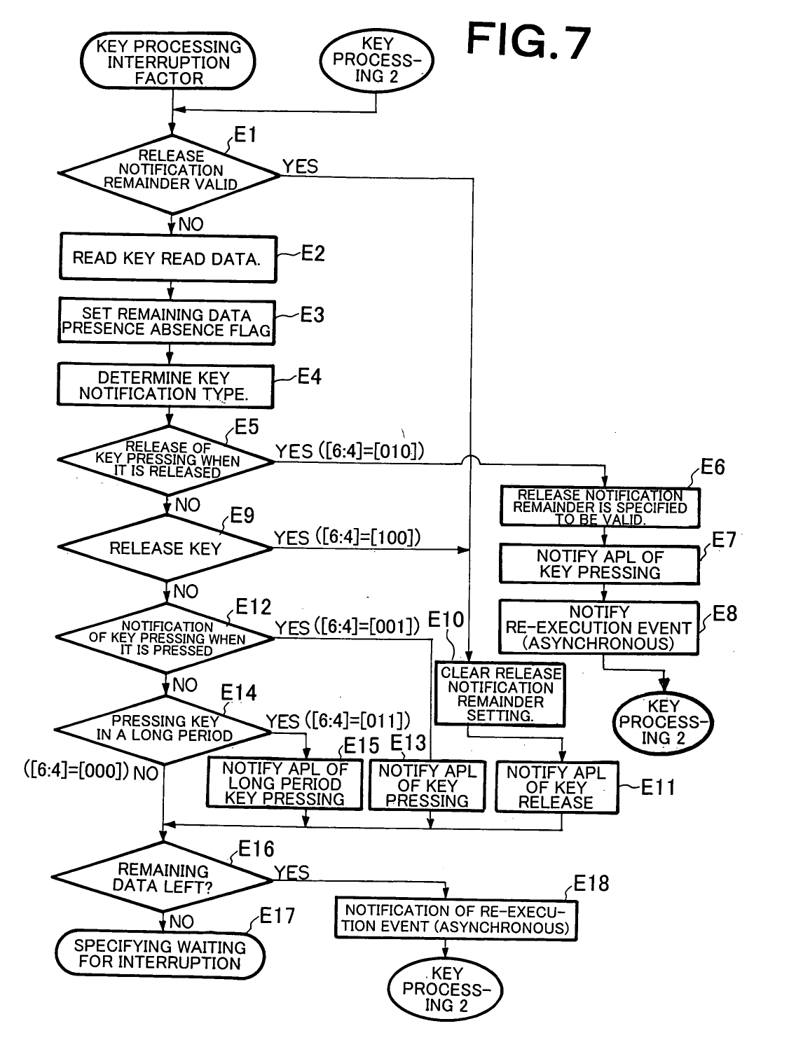

Next, the control procedure of the middleware will be described with reference to the flow chart of FIG. 7. When notified from the key interruption handler, the middleware determines its factor (step El) and if it is not an interruption notification made because release notification remainder described later is set validly, the middleware reads a register corresponding to the key buffer 1-13 of the KC 1-8 (step E2).

The middleware acquires data indicating the type of the key in which the status change occurs and the type of the status change (pressing of key, pressing of key in a long period, release of key, pressing of key in which pressing of the key is notified when it is released, pressing of key in a long period, in which pressing of the key is notified when it is released). This data is regarded as key read data, the format of which is shown in FIG. 10.

As shown in FIG. 10, the key read data is composed of remainder flag 13-1 which indicates whether or not data to be read from the key buffer 1-13 is left, status type 13-2 indicating the type of key status change and key type 13-3 which indicates the key type. If there is left data waiting to be read in the key buffer 1-13, the remainder flag 13-1 of the key read data turns to “1” and if there is no data waiting to be read, the value turns to “0”.

“001” of the status type 13-2 indicates that a corresponding key is pressed to an application using the key pressing notification when it is pressed. “010” indicates that the corresponding key is released to the application using the key pressing notification when it is released. “011” indicates that the long period key pressing is executed effectively. “100” indicates that the key is released and applied to an application using both the key pressing operation and release operation as different trigger like quick feed operation for reproduction of voice and the like.

The middleware sets information indicating whether there exists data waiting to be read in the key buffer 1-13 in a variable like global variable on memory (step E3). The value of the set variable is referred to when the middleware executes reprocessing of a notification of the key event after data read out from the key buffer 1-13 is notified to the application.

Subsequently, the middleware recognizes the key type 13-3 from the read out key read data and the status type 13-2 (step E4). If the status type 13-2 is operation of releasing the key pressing notification when it is released (“010” in FIG. 10), an event of key pressing is notified to the application (step E7) after it is set that remainder of the key release notification exists (step E6).

When user is requested to notify a next event (step E8), the setting of the key release notification remainder is erased (step E10) after the factor determination of step E1 and an event of key release is notified to the application (step E11).

If the status type 13-2 is operation of releasing the key (step E9, FIG. 10: “100”), the middleware notifies the application of an event of key release (step E11). If the status type 13-2 is pressing operation in the notification of the key pressing when it is pressed (step E12, FIG. 10: “001”), the middleware notifies the application of an event of key pressing (step E13) and if the status type 13-2 is long period key pressing (step E14, FIG. 10: “011”), an event of long period key pressing is notified to the application (step E15).

If the remainder flag 13-1 of newly read out key read data is “0” after the event notification is carried out in the above-described procedure, the middleware terminates the notification processing of the key event and waits for new interruption notification from the key interruption handler (step E17). If the remainder flag 13-1 is “1”, event notification is carried out based on the read out key read data in the above-described procedure when a next event notification is requested from the application (step E18).

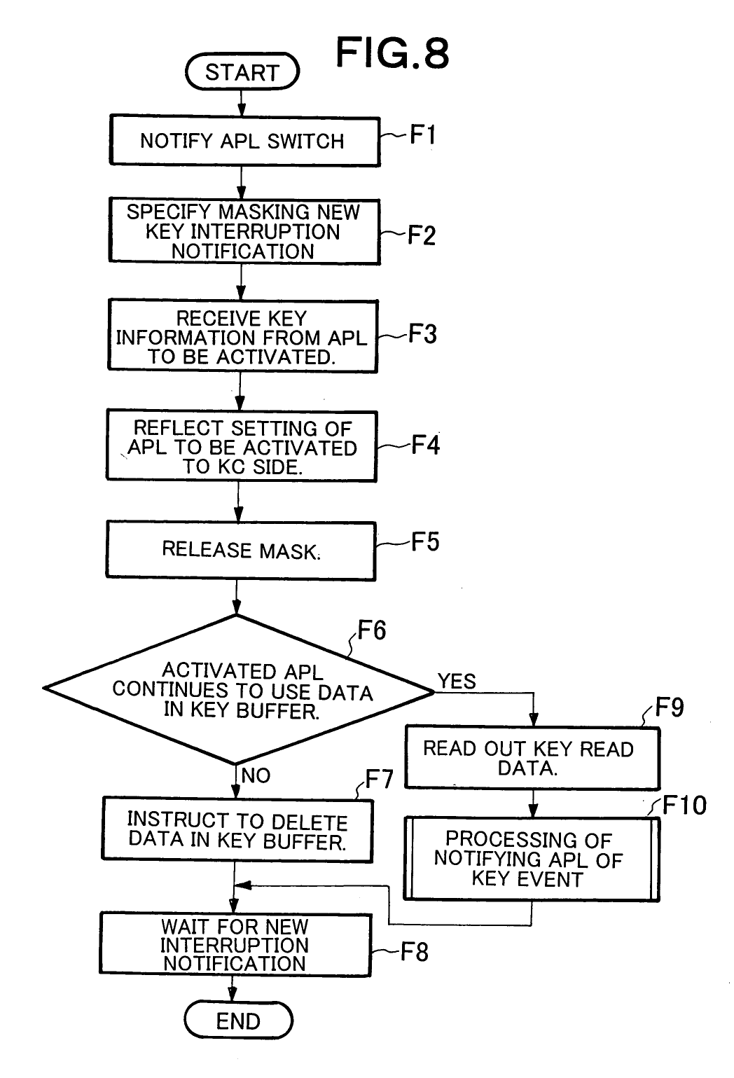

The processing of the middleware when the application is changed over and a situation in which that processing is reflected to hardware will be described with reference to the flow chart of FIG. 8. The middleware mentioned here corresponds to a task bearing the key control in the middleware of the portable information terminal 1.

When the middleware receives a switch notification from another task bearing the switch processing of the application (step Fl), masking a new key interruption notification is executed to the key interruption notification permitting unit 1-14 (step F2). Consequently, the key interruption notification 1-21 from the KC 1-8 to the INTRC 1-9 is stopped temporarily.

Application scheduled to be activated by a switch transmits effective key type and operating style, information about notification style like key pressing notification when it is released, information about whether or not the key buffer 1-13 continues to be used and the like to the middleware.

After receiving the above-described notification (step F3), the middleware reflects setting to the activated application to the key notification information holding unit 1-15 and the valid key information holding unit 1-16 of the KC 1-8 (step F4). More specifically, the middleware instructs the key control unit 1-19 to select information about a difference between before and after the switch of the applications from the key table 1-17 in the key notification information holding unit 1-15 and the valid key information holding unit 1-16 and write those into the register. Consequently, update of all setting in the key notification information holding unit 1-15 and the valid key information holding unit 1-16 becomes unnecessary thereby making the processing efficient.

If the switch of the applications finished because information of the activated application is reflected to the KC 1-8, the middleware releases the mask set in the key interruption permitting unit 1-14 (step F5). As a result, the key interruption notification 1-21 from the KC 1-8 to the INTRC 1-9 is restarted.

Subsequently, the middleware determines whether or not this application continues to use remaining data in the key buffer 1-13 based on information notified preliminarily from the activated application (step F6). As a result, if the remaining data in the current key buffer 1-13 is not used, the middleware instructs the key control unit 1-19 to delete remaining data in the key buffer 1-13 (step F7) and waits for new interruption notification from the key interruption handler (step F8).

On the other hand, if the activated application uses the remaining data in the key buffer 1-13, the middleware automatically reads out key read data from the key buffer 1-13 without depending on a notification from the key interruption handler (step F9). While the remainder flag 13-1 is “1”, the notification of the key event to the application is repeated in the above-described procedure (step F10).

As another plan for control about deletion in the key buffer 1-13, a following method can be considered. Whether or not data in the key buffer 1-13 is to be deleted when the application is activated is set in the key table 1-17 for each application. When the application is activated, the key control unit 1-19 refers to the above-mentioned information set in the key table 1-17 about that application. Consequently, if data left in the key buffer 1-13 is set to be deleted, those data are deleted. If data in the key buffer 1-13 is held in the flip-flop circuit (FF), data may be deleted in batch by reset clear action of this circuit.

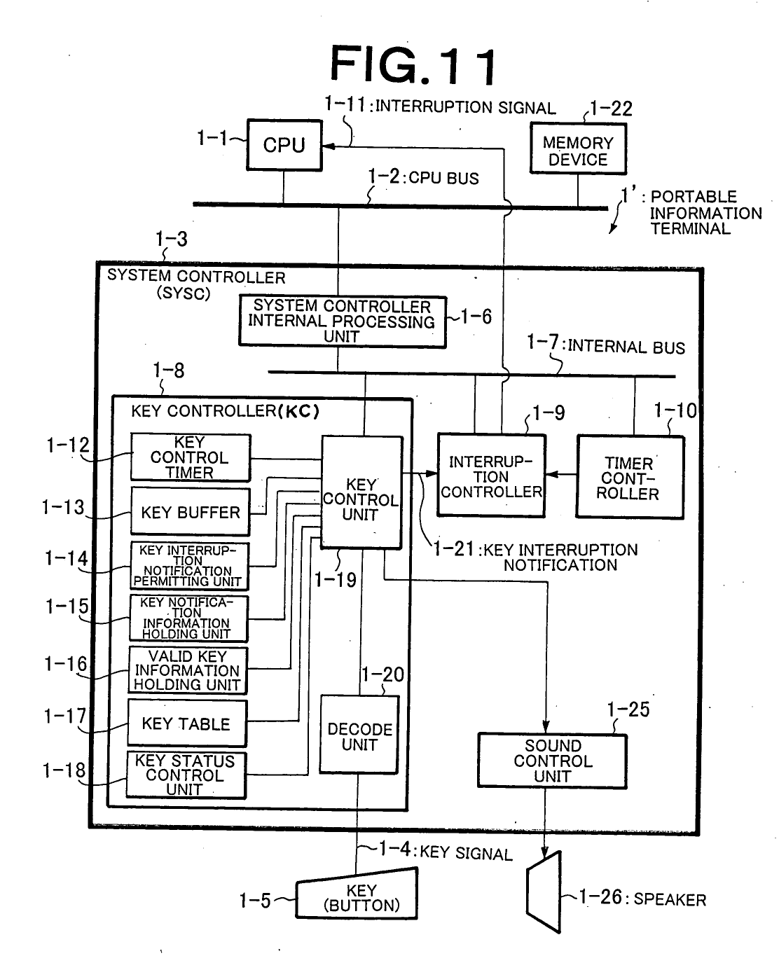

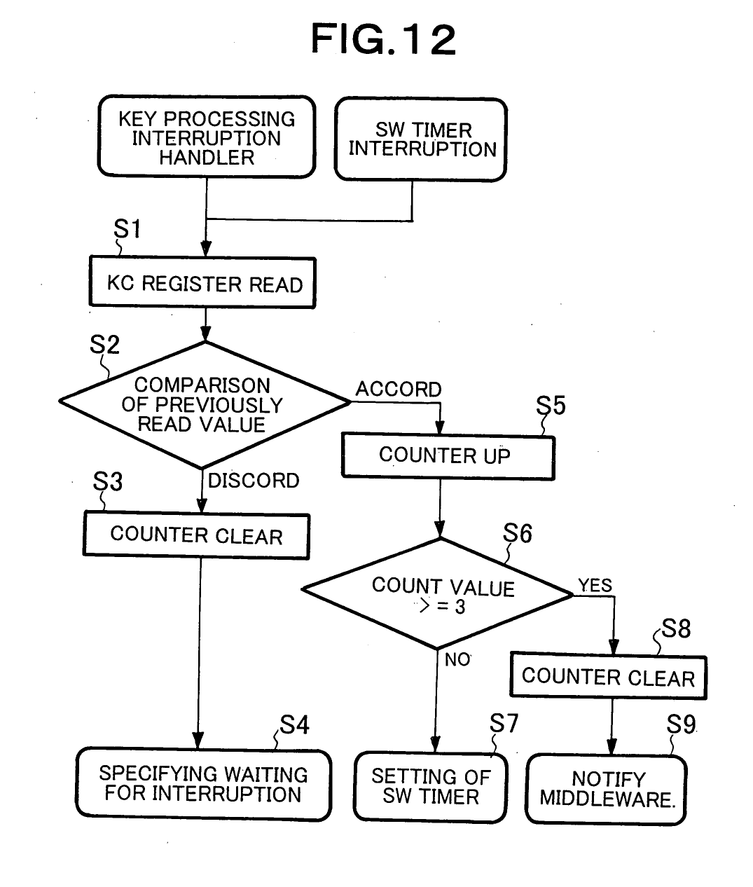

FIG. 11 shows the configuration of another embodiment of the present invention. The configuration of the portable information terminal 1′ of this embodiment includes a sound control unit 1-25 which produces an operation sound from a speaker 1-26 when the key is operated, in cooperation with the key control unit 1-19. When the key control unit 1-19 dispatches a key interruption notification 1-21 to the INTRC 1-9, that is, recognizes an effective key operation, it notifies the sound control unit 1-25 of that matter. The sound control unit 1-25 produces a key operation sound from the speaker 1-26 based on information from the key interruption notification 1-21.

If a key corresponding to the notification of key pressing when it is released, the portable information terminal 1′ of FIG. 11 can control the operation sound not to be produced when the key is pressed but to be produced when it is released after that. If the long period key pressing is set in the key operation style, no operation sound is generated when key pressing time does not satisfy the time condition of the long period pressing. Thus, user can execute the long period pressing operation securely by continuing to press the key until the operation sound is produced.

According to still another embodiment, if the key event of the portable information terminal 1 includes repeat of the long period key pressing as well as the key pressing, the long period key pressing, interruption of system timer (1-10) provided by OS is used to judge the long period pressing repeat carried out by the middleware. In this case, the interruption from the KC 1-8 as the long period key pressing repeat uses the function of the SW timer (TSC: time stamp counter, PIC: programmable interval timer) provided by the kernel 9-1 without notification to the CPU 1-1. If the function of the SW timer is used, SW timer is set on the middleware when the long period key pressing is established and after that, the interruption is notified to the application as a key repeat until the key release interruption notification is received from the KC 1-8.

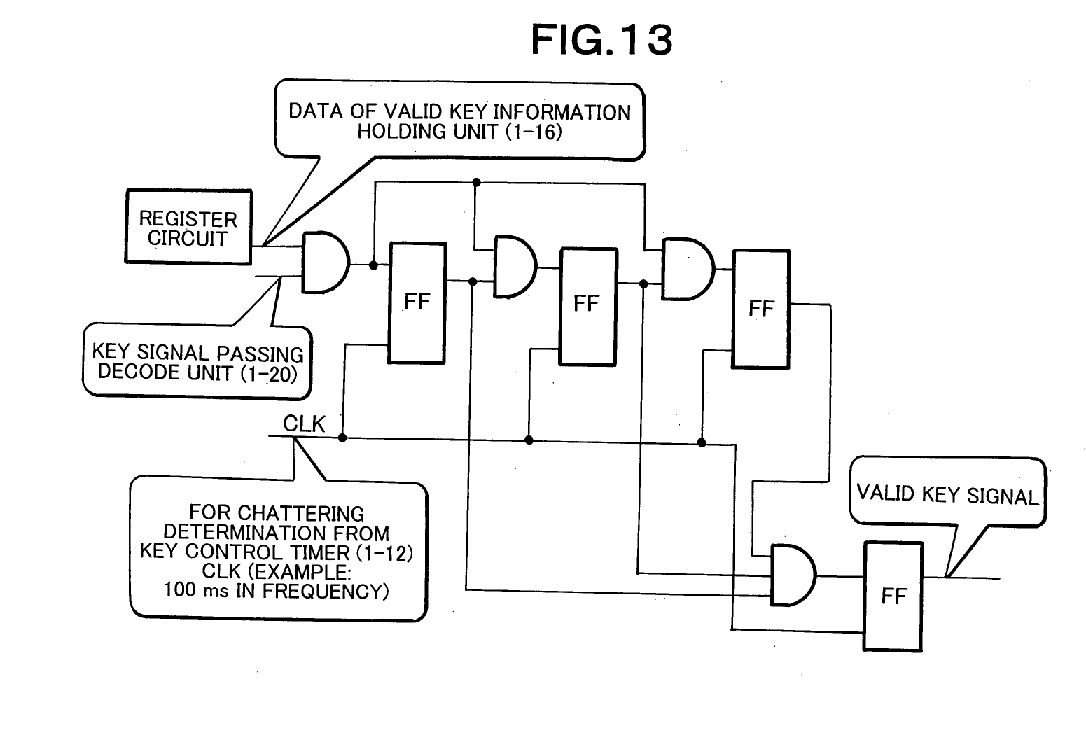

The KC 1-8 of the embodiment can omit waste operation in the chattering determination to the key signal. FIG. 13 shows a circuit for the chattering determination equipped on the KC 1-8. The determining circuit shown in the Figure executes chattering determination on the key signal with a plurality of flip-flop circuits (FF) using the clock signal (CLK) of the key control timer 1-12. When a determination result is valid continuously three times, this key signal is outputted as a valid signal.

As shown in FIG. 13, the input stage of each flip-flop circuit (FF) is provided with AND gate and a key signal passing through the decode unit 1-20 and the value of the valid key information holding unit 1-16 in the register are inputted to the AND gate of a first input stage. According to this embodiment, the flip-flop circuit (FF) is not started until a currently valid key or a key signal corresponding to an application currently being executed is inputted. As a consequence, waste flip-flop operation executed because the currently invalid key operation is made can be reduced, thereby reducing consumption power.

The present invention is preferable for embedded system including a human I/F, for example, the key button. More specifically, such embedded system includes portable phone, car navigation, home robot, digital camera, digital video, and medical equipment and medical terminal which require notification of accurate user operation. Further, power consumption at the time of key operation can be suppressed more efficiently than conventionally by applying the present invention to a battery driven system and the present invention is also effective for prolongation of battery drive time.

Although the exemplary embodiments of the present invention have been described in detail, it should be understood that various changes, substitutions and alternatives can be made therein without departing from the sprit and scope of the invention as defined by the appended claims. Further, it is the inventor's intent to retrain all equivalents of the claimed invention even if the claims are amended during prosecution.

What is claimed is:

1. An embedded system comprising: a key button which user operates; a CPU which executes an application; an interruption controller which supplies a key operation interruption signal to the CPU; and a key controller for notifying the interruption controller of generation of a key interruption based on a key signal indicating a status change of the key button, wherein
the key controller includes:
a key table containing key information which specifies the key type and operation style valid to execution of application by the CPU and notification information which specifies notification style to the interruption controller for each key; and
a key control unit which sets key information and notification information corresponding to an application which the CPU executes, in a register of the key controller and notifies the interruption controller of generation of key interruption corresponding to key operation based on the set information.

2. The embedded system according to claim 1 wherein the key controller includes a buffer which memorizes information about type and operation style indicated by a key signal from the key button and
the key control unit compares memory capacity necessary for information to be stored in the buffer with the amount of space in the buffer and if the amount of space in the buffer is smaller, aborts the information.

3. The embedded system according to claim 2 wherein if notification of a key interruption when the key is released after it is pressed is set as notification information corresponding to the key signal, which indicates that the key is pressed and is to be stored in the buffer, the key control unit retains notification of key interruption relating to the key until the key signal indicating a release of the key is stored into the buffer.

4. The embedded system according to claim 2 wherein the key controller includes a key control timer for timekeeping and;
if long period key pressing which keeps the key pressed in a predetermined period based on the timekeeping of the key control timer is set as key information corresponding to a key signal, which indicates that the key is pressed and is to be stored in the buffer, the key control unit sets the predetermined period in the key control timer and stores information indicating that the long period key pressing is valid when it is notified that the key control timer expires before the key signal indicating release of the key is stored into the buffer.

5. The embedded system according to claim 1 wherein the speaker has a sound control unit for dispatching an acoustic signal to the speaker,
the key control unit notifies the sound control unit of generation of key interruption and
the sound control unit transmits an acoustic signal triggered by a notification from the key control unit.

6. The embedded system according to claim 2 wherein the speaker has a sound control unit for dispatching an acoustic signal to the speaker,
the key control unit notifies the sound control unit of generation of key interruption and
the sound control unit transmits an acoustic signal triggered by a notification from the key control unit.

7. The embedded system according to claim 3 wherein the speaker has a sound control unit for dispatching an acoustic signal to the speaker,
the key control unit notifies the sound control unit of generation of key interruption and
the sound control unit transmits an acoustic signal triggered by a notification from the key control unit.

8. The embedded system according to claim 4 wherein the speaker has a sound control unit for dispatching an acoustic signal to the speaker,
the key control unit notifies the sound control unit of generation of key interruption and
the sound control unit transmits an acoustic signal triggered by a notification from the key control unit.

9. A computer program product which makes a CPU of the embedded system comprising: a key button which user operates; the CPU which executes an application; an interruption controller which supplies a key operation interruption signal to the CPU; and a key controller for notifying the interruption controller of generation of a key interruption based on a key signal indicating a status change of the key button, wherein
the key controller includes a key table containing key information which specifies the key type and operation style valid to execution of application by the CPU and notification information which specifies notification style to the interruption controller for each key, a key control unit which sets key information and notification information corresponding to the application which the CPU executes in a register of the key controller and notifies the interruption controller of generation of key interruption corresponding to key operation based on the set information; and a buffer which memorizes information about type and operation style indicated by a key signal from the key button, and
the key control unit compares memory capacity necessary for information to be stored in the buffer with the amount of space in the buffer and if the amount of space in the buffer is smaller, aborts the information,
execute a step of, when a key operation interruption signal is received from the interruption controller, reading out key read data containing information stored in the buffer from the register and notifying the application of generation of the key event based on the read out key read data; and
a step of specifying to stop notification from the key controller to the interruption controller in the register during switch of the applications.

10. The computer program product according to claim 9 which makes the CPU executes a step of when the switch of applications finished, instructing the key control unit to set key information and notification information corresponding to activated application in the register of the key controller, reading key read data from the register, determining whether or not any information exists in the buffer based on the key read data and if there is not information in the buffer, and specifying releasing of stop of the notification to the interruption controller from the key controller.

11. The computer program product according to claim 9 which makes the CPU execute a step of when the switch of applications finished, setting key information and notification information corresponding to activated application in the register of the key controller, instructing the key control unit to delete information in the buffer and specifying release of stop of the notification to the interruption controller from the key controller after the instruction.

12. A key controller connected to a key button operated by user and an interruption controller for supplying a key operation interruption signal to a CPU executing an application, the key controller comprising:
a determining circuit for executing chattering determination of a key signal indicating a status change of the key button; and
a register circuit holding data indicating the type of a key valid to an application being executed, wherein
the determining circuit has a means for determining whether or not the chattering determination about the key signal from the key button is scheduled to be executed based on data from the register circuit.

13. A key interruption control method in which a key controller connected to a key button operated by user and an interruption controller for supplying a key operation interruption signal to a CPU executing an application
has a key table containing: key information which specifies the key type and operation style valid to execution of the application by the CPU; and notification information which specifies the notification style to the interruption controller for each key,
the key interruption control method comprising setting key information and notification information corresponding to an application which the CPU executes in the register of the key controller; and notifying the interruption controller of generation of a key interruption corresponding to key operation based on the set information.

14. The key interruption control method according to claim 13 wherein, the key controller
has a buffer which memorizes information about the type and operation style indicated by a key signal from the key button; and
compares a memory capacity necessary for information to be stored in the buffer with the amount of space in the buffer and if the amount of space in the buffer is small, aborts the information.

15. The key interruption control method according to claim 14 wherein,
if notification of key interruption when the key is released after it is pressed is set as notification information corresponding to the key signal, which indicates that the key is pressed and is to be stored in the buffer, the key controller retains notification of key interruption relating to the key until the key signal indicating a release of the key is stored in the buffer.

16. The key interruption control method according to claim 14 wherein,
the key controller has a key control timer for timekeeping,
if long period key pressing which keeps the key pressed in a predetermined period based on the timekeeping of the key control timer is set as key information corresponding to a key signal, which indicates that the key is pressed and is to be stored in the buffer, the key controller sets the predetermined period in the key control timer and stores information indicating that the long period key pressing is valid when it is notified that the key control timer expires before a key signal indicating a release of the key is stored in the buffer.

17. The key interruption control method according to claim 15 wherein,
the key controller has a key control timer for timekeeping,
if long period key pressing which keeps the key pressed in a predetermined period based on the timekeeping of the key control timer is set as key information corresponding to a key signal, which indicates that the key is pressed and is to be stored in the buffer, the key controller sets the predetermined period in the key control timer and stores information indicating that the long period key pressing is valid when it is notified that the key control timer expires before a key signal indicating a release of the key is stored in the buffer.

18. An embedded system comprising: a key button which user operates; a CPU which executes an application; an interruption controller which supplies a key operation interruption signal to the CPU; and a key controller for notifying the interruption controller of generation of a key interruption based on a key signal indicating a status change of the key button, wherein
the key controller includes
a key table containing key notification information of each key which specifies a key type and operation style valid to execution of application by the CPU and notification information which specifies the notification style of interruption to the key operation to the interruption controller for each key and
a key control unit which sets key information and notification information corresponding to the application, which the CPU executes, in a register of the key controller and notifies the interruption controller of generation of key interruption corresponding to key operation based on the set information.

19. The embedded system according to claim 18 wherein the key controller includes a buffer which memorizes key operation information notified from the key button, and
the key controller compares memory capacity necessary for key operation information to be stored in the buffer with the amount of space in the buffer based on the key table when detecting that the key is pressed from the key signal of the key button and if the amount of space in the buffer is smaller, aborts the operation information of the key until release of the key is detected.

20. The embedded system according to claim 18 wherein if notification of key interruption when the key is released after it is pressed is set as an operation style of the key in the key table when the key controller detects that the key is pressed from the key signal from the key button, the key controller retains the key interruption notification relating to the key when the key is pressed and notifies of the key interruption when release of the key is accepted.

21. The embedded system according to claim 19 wherein the key controller includes a timer for key control,
if long period key pressing which detects continuously pressing of the key in a predetermined period based on the timer is specified to be valid as an operation style relating to the key in the key table when the key controller detects that the key is pressed from a key signal form the key button, the key controller sets the predetermined period in the timer and when expiration of the period is notified from the timer before release of the key is detected, the key controller determines that the long period key pressing of the key is valid, stores information of the long period key pressing in the buffer and notifies the interruption controller of an interruption request.

22. A computer program product which makes the CPU of the embedded system, comprising: a key button which user operates; a CPU which executes an application; an interruption controller which supplies a key operation interruption signal to the CPU; and a key controller for notifying the interruption controller of generation of a key interruption based on a key signal indicating a status change of the key button, wherein
the key controller includes a key table containing key notification information of each key which specifies a key type and operation style valid to execution of application by the CPU and notification information which specifies the notification style of interruption to the key operation for each key to the interruption controller and a key control unit which sets key information and notification information corresponding to the application, which the CPU executes, in a register of the key controller and notifies the interruption controller of generation of key interruption corresponding to key operation based on the set information, and a buffer which memorizes key operation information notified from the key button,
the key controller compares memory capacity necessary for key operation information to be stored in the buffer with the amount of space in the buffer based on the key table when detecting that the key is pressed from the key signal of the key button and if the amount of space in the buffer is smaller, aborts the operation information of the key until release of the key is detected,
execute a step of, if application switch request is generated when a plurality of applications are activated, masking notification of key interruption from the key controller into the interruption controller; and a step of releasing the mask of notification of interruption from the key controller into the interruption controller after the switch of applications finishes.

23. The computer program product according to claim 22 which makes the CPU execute a step of,
when the applications are switched, setting whether or not the application, which is activated after the switching, uses data held in the buffer of the key controller in the key controller as information of the key table and deleting the data in the buffer before the interruption notification is released if deletion of data held in the buffer of the key controller at the time of application switch is specified based on information of the key table.
